(19) United States
(12) Patent Application Publication
(10) Pub. No.: US 2025/0042768 A1
(43) Pub. Date: Feb. 6, 2025

(54) CATHODE COMPOSITION

(71) Applicant: Dyson Technology Limited, Malmesbury, Wiltshire (GB)

(72) Inventors: Juliette Marie BILLAUD ep. BOUVILLE, Oxford (GB); Matthew Robert ROBERTS, Oxford (GB); Niccolo GUERRINI, Oxford (GB)

(21) Appl. No.: 18/719,361

(22) PCT Filed: Dec. 13, 2022
(86) PCT No.: PCT/GB2022/053191

§ 371 Date: Jun. 13, 2024

(30) Foreign Application Priority Data
Dec. 20, 2021 (GB) 2118531.9

(51) Int. Cl. C01G 53/00; C01G 45/12

(52) U.S. Cl. CPC C01G 53/50; C01G 45/1228; C01P 2002/72; C01P 2006/40

(57) ABSTRACT

There is provided a cathode composition for a battery of the general formula: Mg₁₊ₓNi₁₋ₓO₂ or Mg₁₊ₓMn₁₋ₓO₂; wherein the value of x is greater than 0. There is also provided a method of making the cathode composition for a battery, a cathode containing the cathode composition, and an electrochemical cell containing the cathode.

### TECHNICAL FIELD

The present invention relates to a cathode composition. More specifically, the present invention relates to a cathode composition for a battery. The present invention further relates to a method of making the cathode composition for a battery. The present invention further relates to a cathode comprising the cathode composition and an electrochemical cell comprising the cathode.

### BACKGROUND

Lithium-rich cathode compositions for batteries are widely known. Typically, lithium-rich cathodes require a layered structure, which can lead to problems with defects, trapped lithium ions and collapse of the layers during cycling of the battery. In addition, lithium-rich cathode compositions are usually prepared via high temperature synthesis, which is energy-intensive, expensive and can result in difficulties in controlling the reactions that take place to form the composition. More recently, lithium-rich disordered rock salt (DRS) structures have been investigated as cathode materials. However, it is currently a challenge to improve the energy density in lithium-rich DRS structures with known compositions and methods.

The present invention has been devised to mitigate or overcome at least some of the above-mentioned problems.

### SUMMARY OF THE INVENTION

In accordance with a first aspect of the present invention, there is provided a cathode composition for a battery of the general formula: Mg₁₊ₓNi₁₋ₓO₂ or Mg₁₊ₓMn₁₋ₓO₂; wherein the value of x is greater than 0.

The present invention thereby provides stable and electrochemically-active magnesium-based cathode compositions for batteries. In these compositions, magnesium is the main charge carrier, rather than lithium in traditional lithium-ion batteries. Magnesium-based cathode compositions are synthetically challenging to produce; however the present inventors have shown for the first time that not only can the above magnesium-based cathode compositions be produced, but also that they can be produced in a straightforward manner and cycled.

The compositions themselves are cheaper to produce and more practical than any previously reported cathode composition. In addition, the present inventors have demonstrated electrochemical activity in these compositions for the first time. Advantageously, the magnesium ion intercalation process involves the insertion of two electrons, which enables the energy density and stability of the cathode to be significantly improved in comparison to lithium-based cathode compositions.

The composition may be in the form of a single phase having a rock salt crystal structure such that an x-ray diffraction pattern of the composition using a Cu Ka radiation source has an absence of peaks below a 20 value of 35.

Conventional ordered or layered lithium and manganese-rich compositions (Lₕ₊ₓTmᵢ₋ₓCₖ where Tm is predominately Mn) have lithium ions sitting in both the alkali and transition metal sites. In addition to the above, x-ray diffraction patterns of these conventional compositions will have a peak at a 20 value of 18. However, in the present invention the x-ray diffraction pattern of the cathode composition has an absence of a peak at a 20 value of 18. In other words, the single phase crystal structure of the present invention is absent of any spinel or layered structures, and is considered purely as a single phase rock salt crystal structure. The single phase crystal structure does not exhibit either a R3(bar) m and/or a C2/m space group.

In particular, the compositions are provided as a single phase rock salt crystal structure (i.e. face centred cubic lattice with the Fm3(bar)m space group), which may be a disordered rock salt crystal structure.

The value of x may be equal to or less than approximately 0.3.

The composition may be Mg_{1.2}Ni_{0.8}O₂.

The composition may be Mg_{1.2}Mn_{0.8}O₂.

The value of x may be equal to or less than approximately 0.15.

In accordance with a second aspect of the present invention, there is provided a method of making the cathode composition according to the first aspect, the method comprising: providing a magnesium nickel oxide precursor or a magnesium manganese oxide precursor; high-energy milling the precursor with a plurality of milling balls at a milling speed for a milling time period to form the cathode composition; wherein the magnesium nickel oxide precursor or the magnesium manganese oxide precursor has oxidation states that are equal to the oxidation states of the respective elements in the cathode composition.

Contrary to known high temperature synthesis methods, the present method of making the cathode compositions does not require high temperatures. In addition, the present method provides more control over the oxidation states of the transition metals in the compositions, since the precursors can be selected according to the required oxidation states and applying the method to the precursors results in a cathode composition based on the oxidation states of the precursors without any risk of oxidation during the milling process.

The milling speed may be at least approximately 400 rpm.

The milling speed may be between approximately 400 rpm and approximately 1000 rpm.

The milling speed may be between approximately 400 rpm and approximately 800 rpm.

The milling speed may be approximately 800 rpm.

The milling time period may be between approximately 10 hours and approximately 180 hours.

The milling time period may be between approximately 40 hours and approximately 100 hours.

The milling time period may be between approximately 40 hours and approximately 80 hours.

The milling time period may be between approximately 40 hours and approximately 60 hours.

The ratio of precursor powder to milling balls by weight may be between 1:4 and 1:20.

The magnesium nickel oxide precursor may comprise magnesium oxide and nickel oxide in a molar proportion of 1+x magnesium oxide to 1−x nickel oxide.

The magnesium manganese oxide precursor may comprise magnesium oxide and manganese oxide in a molar proportion of 1+x magnesium oxide to 1−x manganese oxide.

The plurality of milling balls may comprise tungsten carbide.

The high-energy milling may be performed within a ball mill jar comprising tungsten carbide.

The plurality of milling balls may comprise zirconium oxide

The high-energy milling may be performed within a ball mill jar comprising zirconium oxide.

Each of the plurality of milling balls may have a diameter of approximately 0.5 mm to approximately 1 cm.

In accordance with a third aspect of the present invention, there is provided a cathode comprising the cathode composition according to the first aspect.

In accordance with a fourth aspect of the present invention, there is provided an electrochemical cell comprising a cathode according to the third aspect, an electrolyte and an anode.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows electric potential as a function of capacity for the cathode composition Mg_{1.2}Ni_{0.8}O₂ in Example 1;

FIG. 2 shows electric potential as a function of capacity for the cathode composition

Mg_{1.2}Mn_{0.8}O₂ in Example 2; and

FIG. 3 shows X-ray diffraction patterns of the cathode composition Mg_{1.2}Mn_{0.8}O₂ in Example 2.

### DETAILED DESCRIPTION

The present invention relates to a cathode composition for a battery of the general formula: Mg₁₊ₓNi₁₋ₓO₂ or Mg₁₊ₓMn₁₋ₓO₂; wherein the value of x is greater than 0.

The composition has a disordered rock salt structure, i.e. it comprises regions of rock salt having different cations, wherein the regions are disordered. In this way the rock salt effectively forms a composite rock salt material.

The inventors have determined that the cathode composition can be made using a ball milling technique. Starting materials are selected according to the desired cathode material, as will be explained in more detail below. The starting materials are then subjected to ball milling for a milling time period. The ball milling process typically takes place at room temperature, or at low temperatures such that the oxidation state of the metal cations is not altered during the process. Milling parameters can be selected as appropriate. After the ball milling process is complete, the resulting material is the disordered rock salt cathode composition.

The ball milling process advantageously allows the oxidation state of the metals to be maintained into the final cathode composition. In this way, the oxidation state, and hence the final cathode composition, can be carefully controlled.

For the Mg₁₊ₓNi₁₋ₓO₂ composition, the starting material is a magnesium nickel oxide. The magnesium nickel oxide comprises a mixture of MgO and NiO, which is preferably provided in powder form. The ratio of the MgO and NiO is selected according to the value of x in the final composition. In particular the molar ratio of MgO to NiO is 1+x to 1−x.

For the Mg₁₊ₓMn₁₋ₓO₂ composition, the starting material is a magnesium manganese oxide. The magnesium manganese oxide comprises a mixture of MgO and MnO, which is preferably provided in powder form. The ratio of the MgO and MnO is selected according to the value of x in the final composition. In particular the molar ratio of MgO to MnO is 1+x to 1−x.

The ball milling process parameters may be any suitable parameters. In particular:

The ball milling time period is a time that is sufficient to produce the cathode composition, which may be for example at least 10 hours.

The material of the balls and/or the container may be any suitable material such as for example tungsten carbide or zirconium oxide.

A ratio of balls to precursor may be any suitable ratio to provide sufficient milling to produce the cathode composition. For example the ratio of precursor to milling balls by weight may be between 1:4 and 1:20, though other suitable ratios may be used.

The milling speed may be any suitable milling speed that is sufficient to produce the cathode composition, which may be for example at least approximately 400 rpm.

The composition can be incorporated into a cathode in any suitable form.

Aspects of the present invention include a method of making the cathode composition for a battery, a cathode comprising the cathode composition, and an electrochemical cell comprising the cathode.

The present invention will now be illustrated with reference to the following examples.

### EXAMPLE 1

Mg_{1.2}Ni_{0.8}O₂

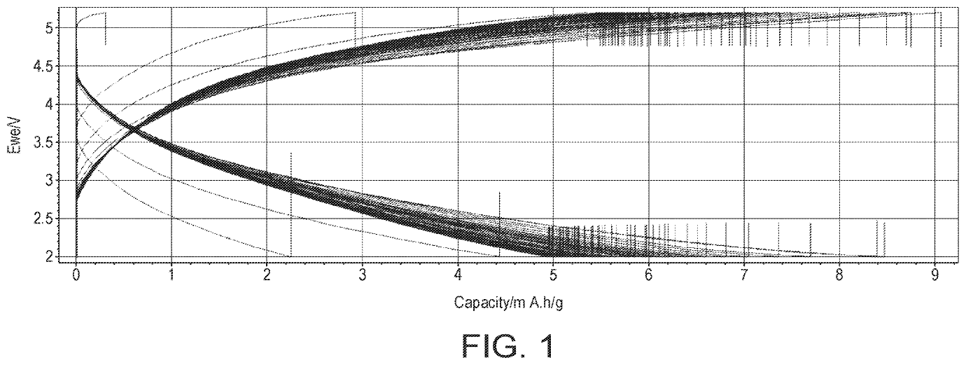

A magnesium nickel oxide (MgNiO₂) precursor was prepared having a molar ratio of 1.2 MgO to 0.8 NiO. This corresponded to 8.95 g (44.75 wt %) MgO and 11.05 g (55.25 wt %) NiO. The precursor was provided in a 20 ml ball mill jar made of tungsten carbide. 80 tungsten carbide milling balls each having a diameter of 5 mm were also provided in the ball mill jar. High-energy milling was used to mill the precursor at a milling speed of 800 rpm for a milling time period of at least 10 hours to form a cathode composition of the formula: Mg_{1.2}Ni_{0.8}O₂. This results in formation of 20 g of Mg_{1.2}Ni_{0.8}O₂ powder inside the ball mill jar. The composition has a disordered rock salt crystal structure. The oxidation state of the Mg in MgO is +2 and the oxidation state of the Ni in NiO is +2. The oxidation states of Mg and Ni in the cathode composition Mg_{1.2}Ni_{0.8}O₂ are also +2. FIG. 1 shows electric potential as a function of capacity for the cathode composition Mg_{1.2}Ni_{0.8}O₂, which demonstrates that the composition can be cycled effectively.

### EXAMPLE 2

Mg_{1.2}Mn_{0.8}O₂

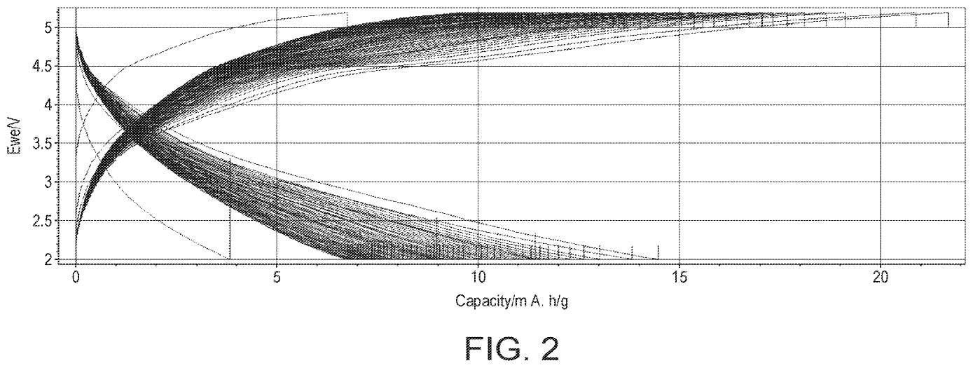

A magnesium manganese oxide (MgMnO₂) precursor was prepared having a molar ratio of 1.2 MgO to 0.8 MnO. This corresponded to 9.20 g (46 wt %) MgO and 10.80 g (54 wt %) MnO. The precursor was provided in a 20 ml ball mill jar made of tungsten carbide. 80 tungsten carbide milling balls each having a diameter of 5 mm were also provided in the ball mill jar. High-energy milling was used to mill the precursor at a milling speed of 800 rpm for a milling time period of at least 10 hours to form a cathode composition of the formula: Mg_{1.2}Mn_{0.8}O₂. This results in formation of 20 g of Mg_{1.2}Mn_{0.8}O₂ powder inside the ball mill jar. The composition has a disordered rock salt crystal structure. The oxidation state of the Mg in MgO is +2 and the oxidation state of the Mn in MnO is +2. The oxidation states of Mg and Mn in the cathode composition Mg_{1.2}Mn_{0.8}O₂ are also +2. FIG. 2 shows electric potential as a function of capacity for the cathode composition Mg_{1.2}Mn_{0.8}O₂, which demonstrates that the composition can be cycled effectively.

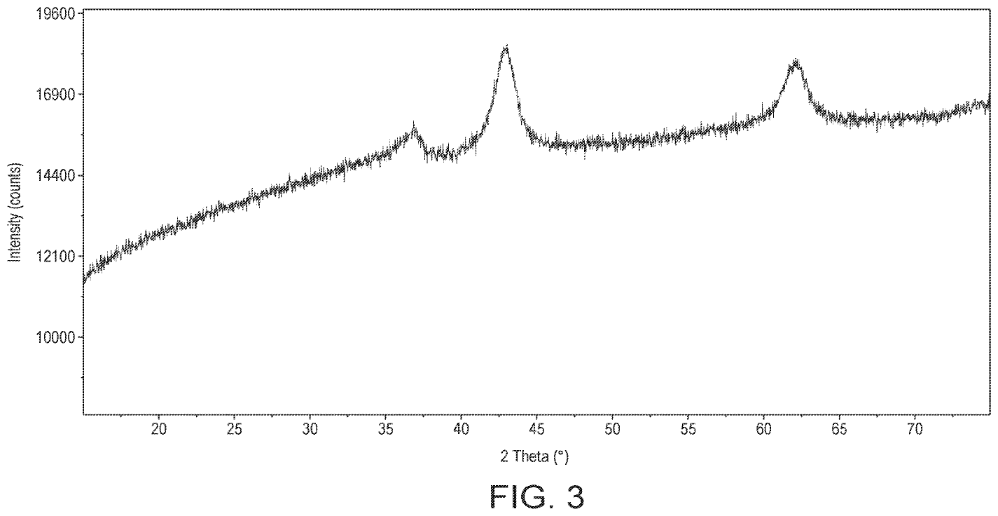

The X-ray diffraction pattern of the cathode composition Mg_{1.2}Mn_{0.8}O₂ is shown in FIG. 3, demonstrating the crystalline structure of the composition. The XRD pattern is characteristic of a cation disordered rock salt structure. The pattern appears to show the broad major peaks consistent with a face centred cubic lattice with the Fm3(bar)m space group, as shown in FIG. 3.

Many modifications may be made to the specific embodiments described above without departing from the scope of the invention as defined in the accompanying claims. Features of one embodiment may also be used in other embodiments, either as an addition to such embodiment or as a replacement thereof.

1. A cathode composition for a battery of the general formula:
Mg₁₊ₓNi₁₋ₓO₂ or Mg₁₊ₓMn₁₋ₓO₂
wherein the value of x is greater than 0.

2. The cathode composition according to claim 1,
wherein the composition has a form of a single phase having a rock salt crystal structure such that an x-ray diffraction pattern of the composition using a Cu Ka radiation source has an absence of peaks below a 20 value of 35.

3. The cathode composition according to claim 1, wherein the value of x is equal to or less than approximately 0.3.

4. The cathode composition according to claim 1, wherein the composition is Mg_{1.2}Ni_{0.8}O₂.

5. The cathode composition according to claim 1, wherein the composition is Mg_{1.2}Mn_{0.8}O₂.

6. The cathode composition according to claim 1, wherein the value of x is equal to or less than approximately 0.15.

7. A method of making the cathode composition according to of claim 1, the method comprising:
providing a magnesium nickel oxide precursor or a magnesium manganese oxide precursor;
high-energy milling the precursor with a plurality of milling balls at a milling speed for a milling time period to form the cathode composition; and
wherein the magnesium nickel oxide precursor or the magnesium manganese oxide precursor has oxidation states that are equal to the oxidation states of the respective elements in the cathode composition.

8. The method according to claim 7, wherein the milling speed is at least approximately 400 rpm.

9. The method according to claim 7, wherein the milling speed is between approximately 400 rpm and approximately 1000 rpm.

10. The method according to claim 7, wherein the milling speed is between approximately 400 rpm and approximately 800 rpm.

11. The method according to claim 7 wherein the milling speed is approximately 800 rpm.

12. The method according to claim 7, wherein the milling time period is between approximately 10 hours and approximately 180 hours.

13. The method according to claim 7, wherein the milling time period is between approximately 40 hours and approximately 100 hours.

14. The method according to claim 7, wherein the milling time period is between approximately 40 hours and approximately 80 hours.

15. The method according to claim 7, wherein the milling time period is between approximately 40 hours and approximately 60 hours.

16. The method according to claim 7, wherein the ratio of precursor powder to milling balls by weight is between 1:4 and 1:20.

17. The method according to claim 7, wherein the magnesium nickel oxide precursor comprises magnesium oxide and nickel oxide in a molar proportion of 1+x magnesium oxide to 1−x nickel oxide.

18. The method according to claim 7, wherein the magnesium manganese oxide precursor comprises magnesium oxide and manganese oxide in a molar proportion of 1+x magnesium oxide to 1−x manganese oxide.

19. The method according to claim 7, wherein the plurality of milling balls comprises tungsten carbide.

20. The method according to claim 19, wherein the high-energy milling is performed within a ball mill jar comprising tungsten carbide.

21. The method according to claim 7, wherein the plurality of milling balls comprises zirconium oxide.

22. The method according to claim 21, wherein the high-energy milling is performed within a ball mill jar comprising zirconium oxide.

23. The method according to claim 7, wherein each of the plurality of milling balls has a diameter of approximately 0.5 mm to approximately 1 cm.

24. A cathode comprising the cathode composition according to claim 1.

25. An electrochemical cell comprising a cathode according to claim 24, an electrolyte and an anode.
